(19) United States
(12) Patent Application Publication
(10) Pub. No.: US 2026/0117924 A1
(43) Pub. Date: Apr. 30, 2026

(54) ADJUSTABLE MAGNETIC MOUNT

(71) Applicant: CKnapp Sales, Inc., Goodfield, IL (US)

(72) Inventors: Micah Fehr, Danvers, IL (US); Jakob Douglas, Washington, IL (US); Ohm Vyas, Geneva, IL (US); Callahan Bauman, Goodfield, IL (US)

(21) Appl. No.: 18/926,066

(22) Filed: Oct. 24, 2024

(51) Int. Cl. F16M 13/02; F16M 11/10

(52) U.S. Cl. CPC F16M 13/022; F16M 11/10

(57) ABSTRACT

Example adjustable magnetic mounts are disclosed herein. An adjustable magnetic mount includes a first region, the first region positioned between a first recess and a second recess, the region including a first magnet, a second region, the second region positioned between the second recess and a third recess, the second region including a second magnet, a third magnet positioned below the second recess, the third magnet positioned between the first magnet and the second magnet, and a high friction material surrounding at least one of the first, second, or third magnet.

### FIELD OF THE DISCLOSURE

This disclosure relates generally to magnetic mounting and, more particularly, to an adjustable magnetic mount.

### BACKGROUND

Magnetic-based mounting permits the attachment of a variety of items to a magnetic surface, ranging from smaller items (e.g., hooks, clips, knobs, etc.) to larger items (e.g., power tools, laptops, monitors, etc.). As such, magnetic mounting improves versatility of usage and positioning.

### BRIEF DESCRIPTION OF THE DRAWINGS

FIG. 1 illustrates an example side view of a front side of an example first magnetic mount used for mounting to a metal surface to support a load.

FIG. 2 illustrates an example side view of a back side of the first magnetic mount of FIG. 1.

FIG. 3A illustrates the back side of the first magnetic mount of FIG. 1, including an example first magnet/silicone positioning on the back side of the mount.

FIG. 3B illustrates another view of the back side of the first magnetic mount, including an example second magnet/silicone positioning on the back side of the mount.

FIG. 4 illustrates an example side view of a mounting of a monitor to a metal surface using the first magnet mount of FIGS. 1, 2, 3A, and 3B.

FIG. 5 illustrates an example side view of a front side of an example second magnetic mount used for mounting to a metal surface to support a load.

FIG. 6 illustrates an example side view of a back side of the second magnetic mount of FIG. 5.

FIG. 7 illustrates another view of the back side of the second magnetic mount, including an example magnet/silicone positioning on the back side of the mount.

FIG. 8 is a flowchart representative of an example method of mounting the example first magnetic mount of FIGS. 1, 2, 3A, and 3B and/or the example second magnetic mount of FIGS. 5, 6, and 7 to an example metal surface to support a load positioned on the first magnetic mount and/or the second magnetic mount.

In general, the same reference numbers will be used throughout the drawing(s) and accompanying written description to refer to the same or like parts. The figures are not necessarily to scale.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

Magnetic mounts can be used in a variety of residential and/or commercial use settings to provide loading support for lighter items (e.g., such as calculators, kitchen accessories, smaller trade tools, etc.) and/or heavier items (e.g., such as laptops, drills, etc.). For example, magnetic mounts can be attached to a wide variety of metal surfaces, depending on the intended usage for load support (e.g., attachment to residential appliances, vehicles, commercial and/or industrial equipment, etc.). In some examples, magnetic mounts can be used as computer workstations, laptop stands, and/or tool-based holders. In some examples, magnetic mounts can be designed from a variety of materials, including metal or plastic, to provide durability and sturdiness. However, there is an existing need for magnetic mounts that are compact in size but able to withstand increased loading while using smaller magnet sizes that retain their attachment to the metal surface.

Examples disclosed herein introduce magnetic mounts that are compact in size and magnetize to a variety of metal surfaces, including, but not limited to, commercial and/or industrial equipment (e.g., heating, ventilation, and air condition (HVAC) units, electrical box doors, metal warehouse racking, vehicle surfaces, etc.), as well as residential appliances (e.g., refrigerators, pegboards, etc.). The magnetic mounts disclosed herein rely on smaller magnets coupled with a high friction material (e.g., a silicone pad) to increase frictional forces. For example, an increase in the frictional force simultaneously increases the sliding resistance of the mount while also preventing an excess magnetic force for a given load/application.

Additionally, coupling of the silicone pad to the magnets as disclosed herein allows for the magnetic mount to slide down the surface of attachment when a load limit is exceeded, while preventing the magnets from scratching the surface due to the presence of the silicone pad as a protective cushion positioned against the surface of attachment. In examples disclosed herein, the number of magnets and/or silicone pad attachments on a given magnetic mount can vary based on a desired load capacity and/or surface of attachment. In examples disclosed herein, the silicone pad can be positioned at a set distance from the magnet(s) to either increase or decrease an offset of the silicone pad from the magnet(s), resulting in changes to the amount of magnetic force applied to the surface of attachment. The magnetic mounts disclosed herein can be implemented in a variety of configurations, including, but not limited to, as small all-purpose trays (e.g., for holding laptops) and/or Video Electronics Standards Association (VESA)-compatible mounts (e.g., for attachment to a monitor). However, the magnet/silicone combination disclosed herein can be used in any other type of product, including, but not limited to, tool holders, tables, adjustable shelves, lighting accessories, attachment devices (e.g., hooks), whiteboards, clipboards, etc.

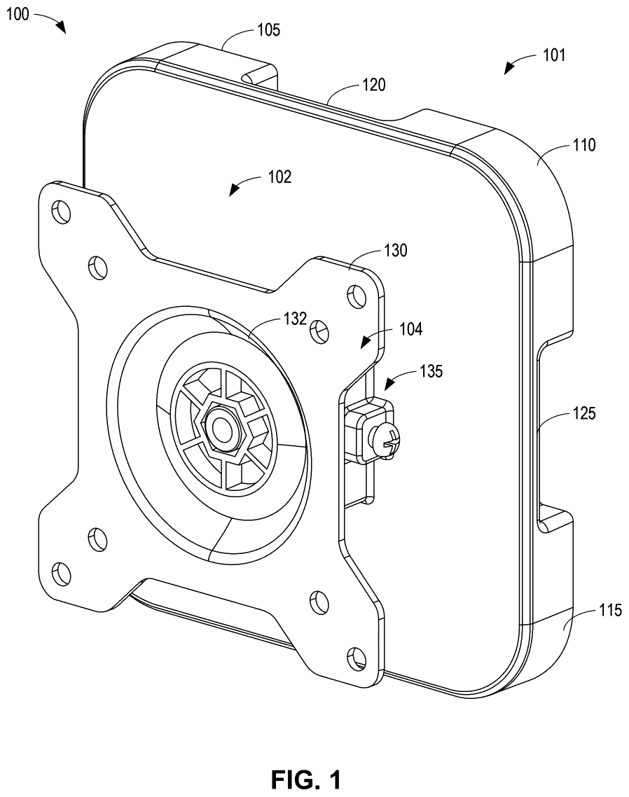

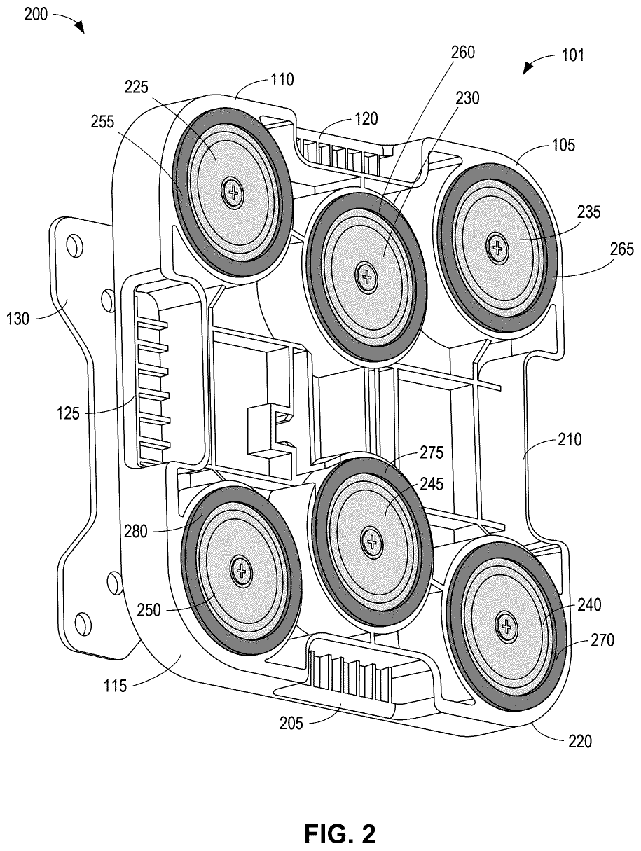

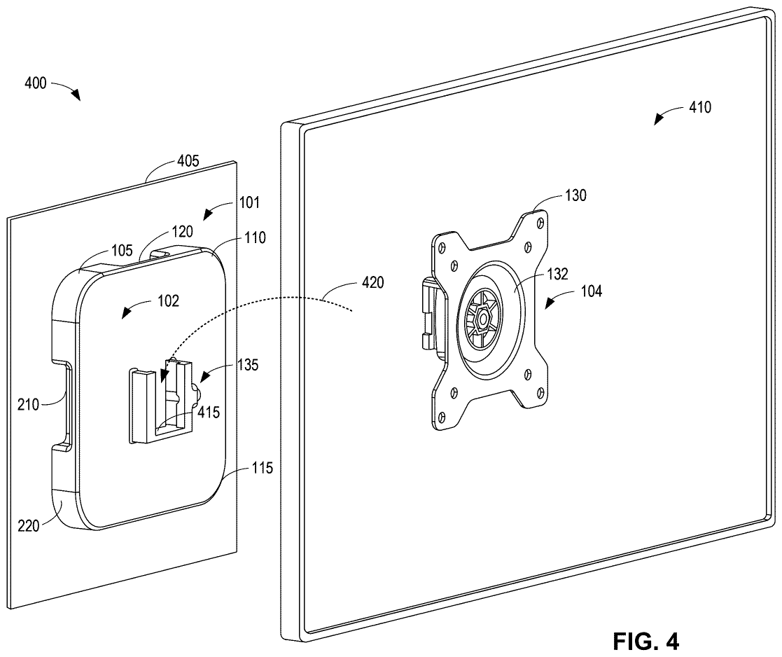

FIG. 1 illustrates an example side view 100 of a front side of an example first magnetic mount 101 used for mounting to a metal surface to support a load. In the example of FIG. 1, the first magnetic mount 101 includes a front surface 102 coupled to a VESA attachment 104. The front surface 102 extends to include a first region 105, a second region 110, and a third region 115. In the example of FIG. 1, the first region 105 and the second region 110 are positioned between a first recess 120 and a second recess 125, as shown and described in more detail in connection with FIG. 2. In the example of FIG. 1, the VESA attachment 104 is a mounting plate with an exterior region 130 and an interior region 132 for mounting a monitor (e.g., by attaching the exterior region 130 to the back of the monitor using a set of screws). As shown in more detail in connection with FIG. 4, the first magnetic mount 101 includes an attachment slot 135 for securing the VESA attachment 104 to the first magnetic mount 101. However, the attachment slot 135 can be used and/or designed for any other type of attachment, not limited to a monitor mounting attachment shown for illustrative purposes in the examples disclosed herein.

FIG. 2 illustrates an example side view 200 of a back side of the first magnetic mount 101 of FIG. 1, including a section of the exterior region 130 of the VESA attachment 104 of FIG. 1. In the example of FIG. 2, the side view 200 includes the first recess 120, the second recess 125, a third recess 205, and a fourth recess 210. The side view 200 also includes the first region 105, the second region 110, the third region 115, and a fourth region 220. In the example of FIG. 2, the first recess 120, the second recess 125, the third recess 205, and the fourth recess 210 are positioned between the first region 105, the second region 110, the third region 115, and the fourth region 220 to allow for the first magnetic mount 101 to be efficiently removed and/or dislodged from the surface of attachment (e.g., a metal surface). In the example of FIG. 2, the first region 105, the second region 110, the third region 115, and the fourth region 220 are positioned towards each edge of the first magnetic mount 101. In the example of FIG. 2, the first region 105, the second region 110, the third region 115, and the fourth region 220 provide support for the positioning of a first magnet 225, a second magnet 235, a third magnet 240, and a fourth magnet 250. Separately, a fifth magnet 230 can be positioned between the first magnet 225 and the second magnet 235. In the example of FIG. 2, the fifth magnet 230 is positioned directly below the first recess 120. Likewise, a sixth magnet 245 can be positioned between the third magnet 240 and the fourth magnet 250. In the example of FIG. 2, the sixth magnet 245 is positioned directly above the third recess 205.

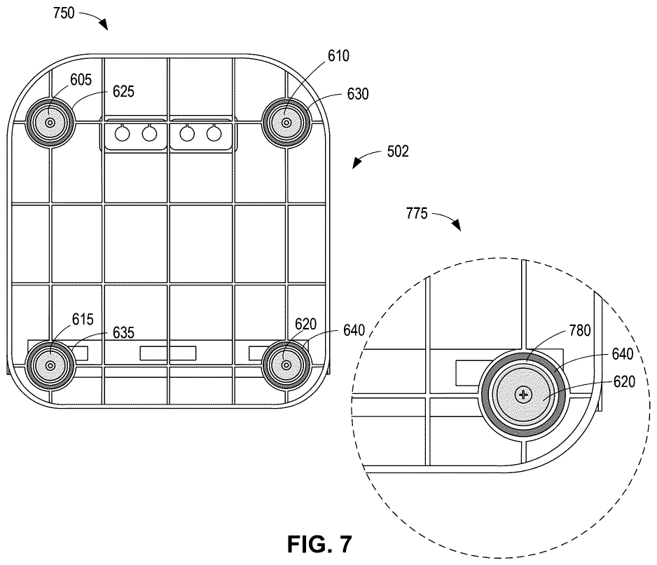

While in the example of FIG. 2 the magnet(s) 225, 230, 235, 240, 245, 250 are shown to be circular, the magnet(s) 225, 230, 235, 240, 245, 250 can be any shape or configuration. In the example of FIG. 2, the magnet(s) 225, 230, 235, 240, 245, 250 are surrounded by silicone pad(s) 255, 260, 265, 270, 275, 280, respectively. However, any other type of high friction material can be used (e.g., rubber, etc.). In some examples, the silicone pad(s) 255, 260, 265, 270, 275, 280 can be positioned directly surrounding the magnet(s) or at an offset from the magnet(s) 225, 230, 235, 240, 245, 250, as described in more detail in connection with FIG. 7. In some examples, the one or more silicone pad(s) 255, 260, 265, 270, 275, 280 can be any shape and/or positioned at any distance relative to the one or more magnet(s) 225, 230, 235, 240, 245, 250. For example, the silicone pad(s) 255, 260, 265, 270, 280 provide a surface that has an elevated level of friction (e.g., a coefficient of friction of approximately 1.0-2.1, depending on the mounting surface characteristics) when sliding against surfaces of relatively higher strength due to silicone-based surface properties, generating a significant amount of resistance against sliding motions. For example, as compared to a silicone rubber surface coated with silicone powder, the coefficient of friction is significantly higher for the bare silicone rubber (e.g., approximately 2.0 for bare silicone as compared to approximately 0.7 for powdered silicone, with a 70% increase in friction using the bare silicone rubber as part of a sliding friction test performed on various contact surfaces).

As described herein, presence of the silicone pad(s) 255, 260, 265, 270, 280 provides additional resistance to sliding of the magnet(s) 225, 230, 235, 240, 245, 250 and/or protects the mounting surface from scratching (e.g., scratches on a metal surface resulting from the sliding down of the magnets under increased loading of the magnetic mount). In some examples, the friction associated with the silicone material can be modified using surface coating(s) and/or treatment(s) (e.g., coating with powdered silicone to reduce friction, performing gas plasma treatment to increase silicone surface energies, etc.). In some examples, the silicone material can have a varying coefficient of friction, which corresponds to the silicone's resistance to sliding along a given surface. For example, the coefficient of friction can be modified based on an intended application of the magnetic mount (e.g., attachment to a surface with a particular steel gauge measurement). For example, the coefficient of friction will be higher when the silicone material is in contact with a rough surface as opposed to a smoother surface. In some examples, temperature can also affect the coefficient of friction, such that lower temperatures can cause a decrease in the coefficient of friction, allowing for the silicone to slide more readily. As such, the silicone pad(s) 255, 260, 265, 270, 280 can be selected based on the intended application of the mount, which can take into consideration expected surface temperature(s) of the mounting surfaces and/or expected surface topographies. In examples disclosed herein, the magnet(s) 225, 230, 235, 240, 245, 250 correspond to a means for attaching the adjustable magnetic mount to a mounting surface. In examples disclosed herein, the silicone pad(s) 255, 260, 265, 270, 280 correspond to a means for regulating a friction of the adjustable magnetic mount relative to the mounting surface. While in the example of FIG. 2 the silicone pad(s) 255, 260, 265, 270, 280 are shown in combination with the magnet(s) 225, 230, 235, 240, 245, 250, any other arrangement or variation of the silicone pad(s) and/or magnet(s) can be used (e.g., no silicone pads, a defined number of silicone pads, a defined number of magnets, etc.).

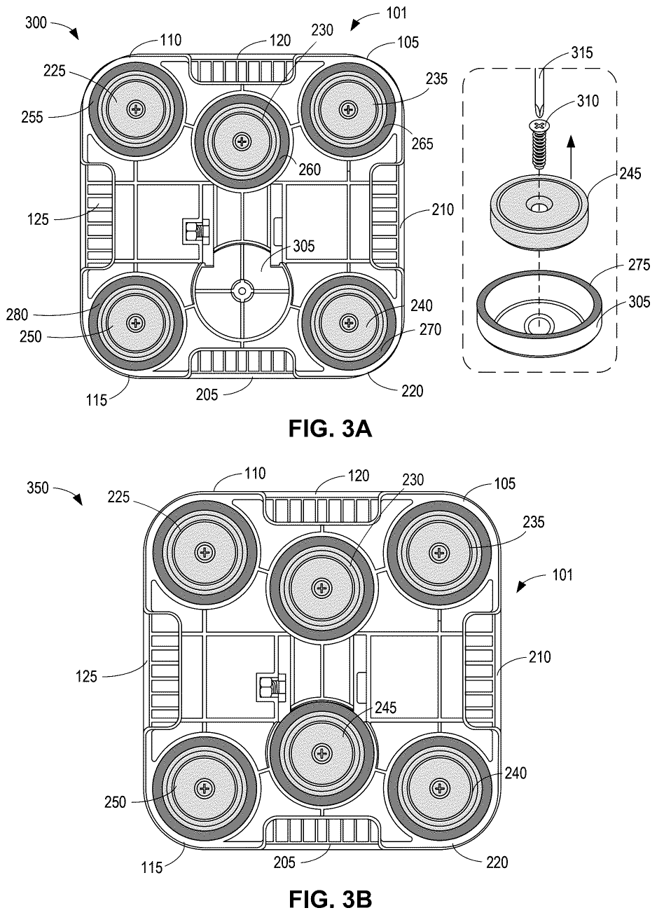

FIG. 3A illustrates the back side of the first magnetic mount 101 of FIG. 1, including an example first magnet/silicone positioning 300 on the back side of the mount. In the example of FIG. 3A, the magnet(s) 225, 230, 235, 240, 250 are shown positioned in region(s) 105, 110, 115, 220, adjacent to recesses 120, 125, 205, 210. As shown in the example of FIG. 3A, one of the magnets (e.g., sixth magnet 245) can be removed and/or not positioned on the back side of the first magnetic mount 101 during assembly. In some examples, a placeholder (e.g., placeholder 305) is included on the back side of the first magnetic mount 101 for the magnet (e.g., sixth magnet 245) to be repositioned as needed. While in the example of FIG. 3A the sixth magnet 245 is shown as being removed, any other of the magnet(s) 225, 230, 235, 240, 250 can be removed from the back side of the first magnetic mount 101, as needed (e.g., based on a desired mount loading capacity). FIG. 3A also illustrates an example positioning of the sixth magnet 245 within the placeholder 305 (e.g., using a screw 310 secured by a screwdriver 315 within the center of the magnet 245). In the example of FIG. 3A, the silicone pad(s) 255, 260, 265, 270, 280 are positioned around the magnet(s) 225, 230, 235, 240, 250, as described in connection with FIG. 2. In some examples, the placeholder 305 includes the silicone pad 275 even if a magnet is not positioned within the placeholder 305 (e.g., providing an additional point of contract between the metal surface of attachment and the first magnetic mount 101). In some examples, the silicone pad 275 can be removed if the corresponding magnet (e.g., sixth magnet 245) is not attached to the first magnetic mount 101.

FIG. 3B illustrates another view of the back side of the first magnetic mount 101, including an example second magnet/silicone positioning 350 on the back side of the mount. In the example of FIG. 3B, all magnet/silicone pairs are intact (e.g., all of the magnet(s) 225, 230, 235, 240, 245, 250 that are able to fit on the first magnet mount 101 are included in the final assembly). In examples disclosed herein, the magnet(s) 225, 230, 235, 240, 245, 250 are installed based on the intended mounting surface thickness. For example, a mounting surface with a steel gauge of 1 millimeter to 1.5 millimeters (e.g., kitchen appliances, HVAC ducts, metal pegboards, etc.) can support the first magnetic mount 101 having a total of 5-6 magnets (e.g., for a weight capacity of 4 kilograms). Alternatively, a mounting surface with a steel gauge of 1.5 millimeters to 2 millimeters (e.g., large shelving, utility cabinets, panels, etc.) can support the first magnetic mount 101 having a total of 6 magnets (e.g., for a weight capacity of 8 kilograms). Likewise, a mounting surface with a steel gauge of 2 millimeters and thicker (e.g., I-beams, structural columns, etc.) can support the first magnetic mount 101 having a total of 5-6 magnets (e.g., for a weight capacity of 8 kilograms). In some examples, the weight capacity can be affected by the thickness, coating, and/or texture of the mounting surface. Any arrangement of the magnet(s) and/or silicone pad(s) on the back side of the first magnetic mount 101 can be used, depending on the intended mounting surface and/or final loading capacity of the mount. In some examples, any high friction material (e.g., rubber, polyurethane, nitrile, etc.) other than silicone can be used in combination with the magnet(s). For example, the high friction material(s) can be selected based on the type of mounting surface (e.g., any type of ferromagnetic-based material not limited to steel).

FIG. 4 illustrates an example side view 400 of a mounting of a monitor to a metal surface using the first magnet mount 101 of FIGS. 1, 2, 3A, and 3B. In the example of FIG. 4, the first magnet mount 101 is attached to a mounting surface 405 via the magnet(s) 225, 230, 235, 240, 245, 250 of FIGS. 2, 3A, and/or 3B, such that the region(s) 105, 110, 115, 220 are positioned flush against the mounting surface 405. As previously described, the recesses (e.g., first recess 120, fourth recess 210, etc.) can be used to position and/or reposition the first magnet mount 101 on the mounting surface 405. In the example of FIG. 4, a monitor 410 is connected to the VESA attachment 104 (e.g., via the exterior region 130 and/or the interior region 132) and mounted into a channel opening 415 of the attachment slot 135 using a vertical motion 420. In examples disclosed herein, the magnet/silicone combination described in connection with FIGS. 2, 3A, and 3B allows for the first magnet mount 101 to sustain a greater loading capacity (e.g., loading capacity of 12.7 pounds without silicone pad(s) versus 28.3 pounds with silicone pad(s) at an offset of zero millimeters relative to the magnet(s)) as compared to the use of magnets alone, as described in connection with FIGS. 2 and/or 7. In some examples, the magnet(s) 225, 230, 235, 240, 245, 250 of FIGS. 2, 3A, and/or 3B can be of varying size(s) and/or strength(s). In some examples, the silicone pad(s) 255, 260, 265, 270, 275, 280 can be modified and/or selected based on the mounting surface 405 material property characteristics (e.g., surface temperature, topography, etc.) to identify a desired coefficient of friction associated with the silicone pad(s). For example, the coefficient of friction can be identified based on the mounting surface characteristics (e.g., as determined using sliding tests identifying the amount of friction introduced by the silicone pads when placed in direct contact with the given mounting surface). In some examples, the coefficient of friction can be selected within a given range (e.g., 1.0-2.0 range) to ensure a high enough friction component to prevent sliding of the magnets in the presence of additional loading. By modifying the silicone pad(s) to provide greater magnetic mount loading capacity without increasing the size of the magnets, the magnetic mount can be maintained at a compact size (e.g., 152 mm by 152 mm) while providing the necessary load bearing needed for a given mounting surface (e.g., as characterized using a thickness of the mounting surface).

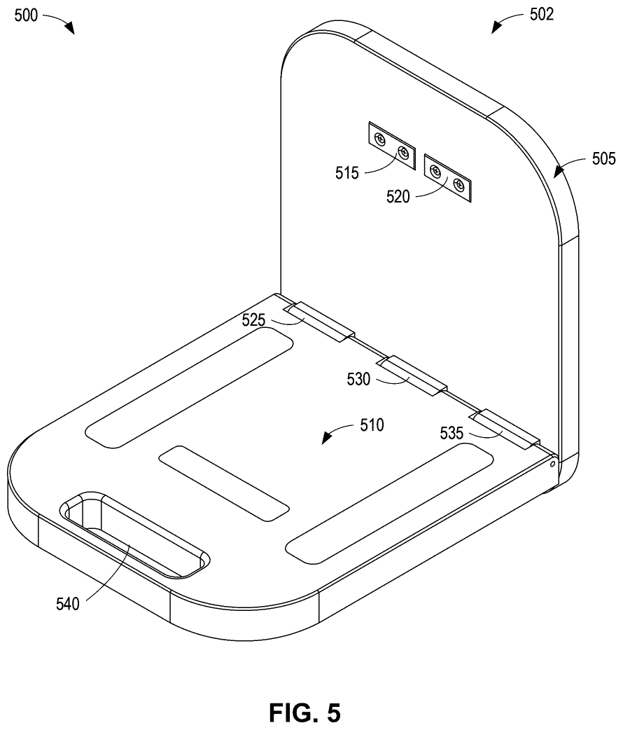

FIG. 5 illustrates an example side view 500 of a front side of an example second magnetic mount 502 used for mounting to a metal surface to support a load. In the example of FIG. 5, the second magnetic mount 502 includes a first section 505 and a second section 510. In some examples, the first section 505 includes a set of magnet(s) 515, 520 that can be used for the attachment of small-sized accessories (e.g., scissors, metal-based tools, etc.). In the example of FIG. 5, the first section 505 can be coupled to the second section 510 via a first hinge 525, a second hinge 530, and/or a third hinge 535. In some examples, the second section 510 includes a handle 540 to allow for the second magnetic mount 502 to be opened or closed (e.g., bringing the section(s) 505, 510 together or moving the section(s) 505, 510 apart from each other). As such, the second magnetic mount 502 can be opened and/or closed after attachment to allow for the positioning and/or removal of a load (e.g., such as a laptop placed on the second section 510).

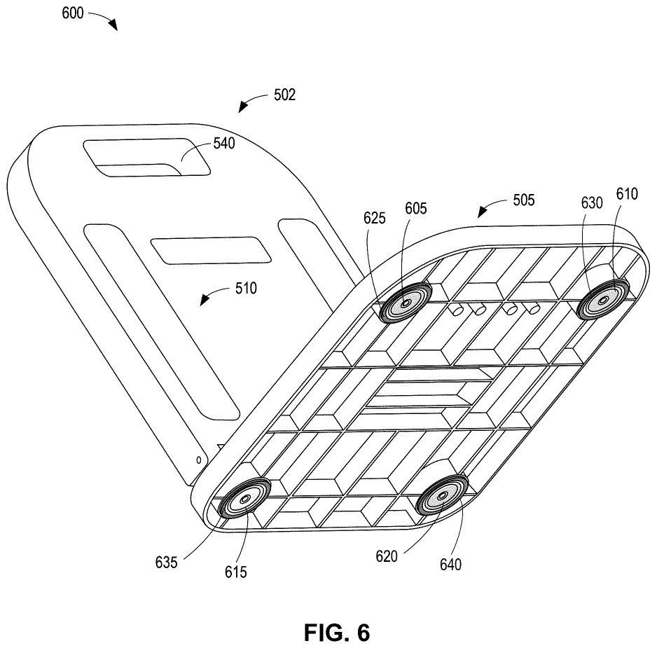

FIG. 6 illustrates an example side view 600 of a back side of the second magnetic mount 502 of FIG. 5. In the example of FIG. 6, the first section 505 is used to attach the second magnetic mount 502 to a mounting surface, while the second section 510 is pulled away from the mounted first section 505 (e.g., using the handle 540). In the example of FIG. 6, the second magnetic mount 502 includes magnet(s) positioned on a back side of the first section 505. For example, magnet(s) 605, 610, 615, 620 are positioned on each corner of the first section 505, with silicone pad(s) 625, 630, 635, 640 surrounding the magnet(s) 605, 610, 615, 620, as described in more detail in connection with FIG. 7. However, any other type of high friction material can be used (e.g., rubber, etc.). In examples disclosed herein, the second magnetic mount 502 can be used for residential purposes (e.g., mounting on a refrigerator, metal pegboard, kitchen appliance, etc.) and/or commercial purposes (e.g., mounting on a steel beam, HVAC, metal door, etc.). In examples disclosed herein, residential use implies mounting the second magnetic mount 502 on a surface with a steel gauge of 1 millimeter (e.g., providing a load capacity of 4.5-6.8 kilograms), whereas commercial use implies mounting the second magnetic mount 502 on a surface with a steel gauge of 1 millimeter to 3 millimeters (e.g., providing a load capacity of 6.8-22.6 kilograms). In examples disclosed herein, the magnet(s) 605, 610, 615, 620 correspond to a means for attaching the adjustable magnetic mount to a mounting surface. In examples disclosed herein, the silicone pad(s) 625, 630, 635, 640 correspond to a means for regulating a friction of the adjustable magnetic mount relative to the mounting surface. While in the example of FIG. 6 the silicone pad(s) 625, 630, 635, 640 are shown in combination with the magnet(s) 605, 610, 615, 620, any other arrangement or variation of the silicone pad(s) and/or magnet(s) can be used (e.g., no silicone pads, a defined number of silicone pads, a defined number of magnets, etc.). In some examples, the magnet(s) 605, 610, 615, 620 can be of varying size(s) and/or strength(s).

FIG. 7 illustrates another view 750 of the back side of the second magnetic mount 502, including an example magnet/silicone positioning on the back side of the mount. In the example of FIG. 7, the magnet(s) 605, 610, 615, 620 and corresponding silicone pad(s) 625, 630, 635, 640 are positioned to provide a desired level of loading capacity. In some examples, as shown in connection with a magnified view 775, the silicone pad (e.g., silicone pad 640) is positioned at an offset 780 from the magnet (e.g., magnet 620). The offset 780 can be modified to either increase or decrease the loading capacity of the mount (e.g., second magnetic mount 502). For example, as shown in connection with Table 1 below, the silicone pad can be positioned at an offset (e.g., offset 780) ranging from 0 millimeters (e.g., relative to the magnet) and up to 0.8 millimeters. For testing performed on a mounting surface having a thickness of approximately 0.5 millimeters (e.g., a metal door), additional weight causing the second magnetic mount 502 to slide down ranged from 12.7 pounds (e.g., in the absence of a silicone pad) and up to 28.3 pounds (e.g., with an offset of 0 millimeters between the magnet and the silicone pad). Increasing the offset between the magnet and the silicone pad resulted in an overall decrease in the loading capacity of the second magnetic mount 502 as compared to having a total offset of zero millimeters between the magnet(s) and silicone pad(s) of the second magnetic mount 502. As such, the offset value(s) can be adjusted based on a desired loading capacity of the magnetic mount. In some examples, the offset 780 is set as close to zero as possible while maintaining a positive offset to take into consideration manufacturing tolerances (e.g., an offset of 0.4 mm+/−0.4 mm).

| Offset Between Silicone | Added Weight Causing Unit |
|---|---|
| Pad and Magnet (mm) | to Slide Down (lb) |
| No Silicone Pad | 12.7 |
| 0 | 28.3 |
| 0.2 | 21.1 |
| 0.4 | 19.1 |
| 0.8 | 16.7 |

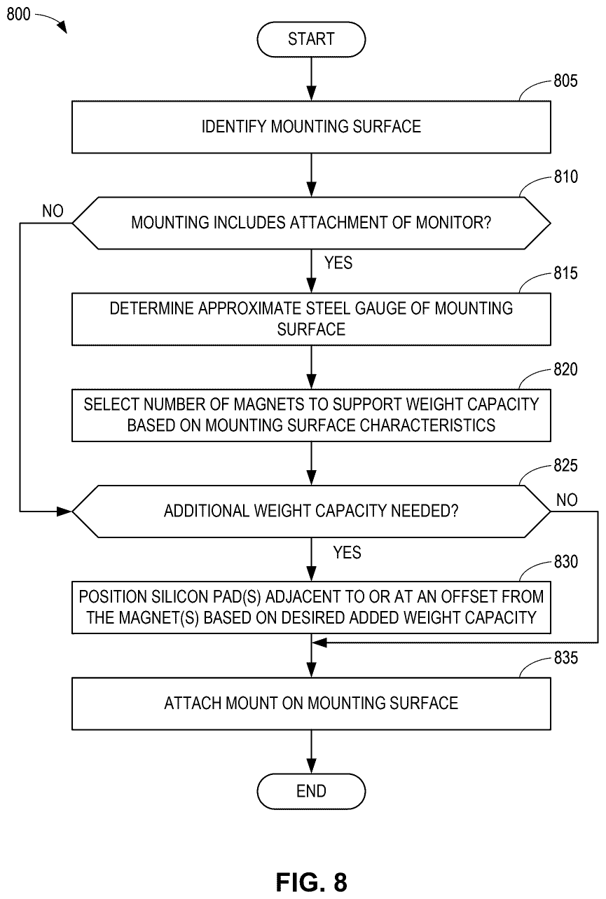

FIG. 8 is a flowchart representative of an example method 800 of mounting the example first magnetic mount 101 of FIGS. 1, 2, 3A, and 3B and/or the example second magnetic mount 502 of FIGS. 5, 6, and 7 to an example metal surface to support a load positioned on the first magnetic mount 101 and/or the second magnetic mount 502. At block 805, the method 800 includes identifying a mounting surface. For example, the mounting surface can include a residential-based (e.g., refrigerator) or a commercial-based (e.g., structural steel of an I-beam) mounting surface. In some examples, the mounting surface can vary in topography (e.g., rough surface versus a smooth surface) and/or temperature. In some examples, the mounting surface can vary in surface area and/or thickness. In the example of FIG. 8, the method 800 includes determining whether mounting using a magnetic mount disclosed herein includes the attachment of a monitor, at block 810. If the mounting includes the attachment of a monitor, the method 800 includes determining an approximate steel gauge associated with the mounting surface, at block 815. For example, the steel gauge of the mounting surface can range from 1 millimeter to 3 millimeters. Based on the identified steel gauge, the method 800 includes selecting a number of magnets to support the weight capacity based on the mounting surface characteristics, at block 820. For example, the mounting of a monitor can be performed using the first magnetic mount 101 of FIG. 1, which includes a VESA attachment (e.g., VESA attachment 104). The first magnetic mount 101 includes a set of magnets (e.g., magnet(s) 225, 230, 235, 240, 245, 250), the total number of which can be modified based on the mounting surface thickness.

In some examples, the method 800 determines whether additional weight capacity is needed based on the mounting surface, at block 825. If additional weight capacity is needed, the method 800 includes positioning a high friction material (e.g., silicone pad(s)) adjacent to, or at an offset from, the magnet(s), at block 830. For example, as described in connection with FIG. 2, magnet(s) 225, 230, 235, 240, 245, 250 are surrounded by silicone pad(s) 255, 260, 265, 270, 275, 280. In some examples, the silicone pad(s) can be positioned directly surrounding the magnet(s) and/or at a set offset from the magnet(s). In some examples, the silicone pad(s) can be selected based on a desired coefficient of friction needed to increase the magnetic mount loading capacity. In some examples, the silicone pad(s) can be surface treated to increase and/or decrease adhesion of the silicone to the mounting surface. In some examples, the high friction material is pre-positioned relative to the magnets based on the mounting surface characteristics and/or intended usage of the magnetic mount. In the example of FIG. 8, if the mounting does not include the attachment of a monitor, as determined at block 810, the method 800 can select the second magnetic mount 502 for support of items such as laptops and/or power tools, etc. As described in connection with FIG. 7, the magnet(s) 605, 610, 615, 620 associated with the second magnetic mount 502 can include silicone pad(s) 625, 630, 635, 640 positioned at an offset from the magnet(s) 605, 610, 615, 620. Such an offset can be determined based on the desired final loading capacity of the magnetic mount. In some examples, the silicone pad(s) can be varied and/or modified based on the mounting surface characteristics (e.g., topography, temperature, etc.), as described in connection with FIG. 2. Once the appropriate mount is selected and modified (e.g., desired number of magnets selected, desired number and/or type of silicone padding selected and attached, desired offset of the silicone padding from the magnet(s) identified, etc.), the method 800 includes attaching the mount (e.g., first magnetic mount 101, second magnetic mount 502) to the mounting surface, at block 835.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

From the foregoing, it will be appreciated that example systems, apparatus, articles of manufacture, and methods have been disclosed that introduce magnetic mounts that are compact in size and magnetize to a variety of metal surfaces. In examples disclosed herein, the magnetic mounts rely on smaller magnets coupled with a high friction material (e.g., a silicone pad) to increase frictional forces. In examples disclosed herein, the number of magnets and/or silicone pad attachments on a given magnetic mount can vary based on a desired load capacity and/or surface of attachment. The magnet/silicone combination disclosed herein can be used in any type of product, including, but not limited to, tool holders, tables, adjustable shelves, lighting accessories, attachment devices (e.g., hooks), whiteboards, and/or clipboards.

Example magnetic mounts are disclosed herein. Further examples and combinations thereof include the following:
Example 1 includes an adjustable magnetic mount comprising a first region, the first region positioned between a first recess and a second recess, the first region including a first magnet, a second region, the second region positioned between the second recess and a third recess, the second region including a second magnet, a third magnet positioned below the second recess, the third magnet positioned between the first magnet and the second magnet, and a high friction material surrounding at least one of the first, second, or third magnet.

Example 2 includes the adjustable magnetic mount of example 1, wherein the high friction material is a silicone pad positioned at an offset from the first, second, or third magnet.

Example 3 includes the adjustable magnetic mount of example 1, wherein a position of the high friction material is adjusted based on a weight capacity of the adjustable magnetic mount.

Example 4 includes the adjustable magnetic mount of example 3, wherein an offset of the high friction material from the first, second, or third magnet is (1) increased to reduce the weight capacity or (2) decreased to increase the weight capacity.

Example 5 includes the adjustable magnetic mount of example 1, further including a fourth magnet and a fifth magnet, the fourth magnet and the fifth magnet positioned on a third region and a fourth region, respectively.

Example 6 includes the adjustable magnetic mount of example 5, further including a sixth magnet positioned between the fourth magnet and the fifth magnet, the sixth magnet positioned below the third magnet.

Example 7 includes the adjustable magnetic mount of example 6, wherein at least the first, second, third, fourth, fifth, or sixth magnet is removed to accommodate a mounting surface with a steel thickness of more than 2 millimeters.

Example 8 includes the adjustable magnetic mount of example 6, wherein, when the first, second, third, fourth, fifth, and sixth magnets are positioned on a back side surface of the adjustable magnetic mount, the adjustable magnetic mount has a weight capacity of at least 8 kilograms.

Example 9 includes the adjustable magnetic mount of example 1, further including a Video Electronics Standards Association (VESA) mount slot on a front side surface, the front side surface opposite the first, second, or third magnet.

Example 10 includes the adjustable magnetic mount of example 9, wherein the VESA mount on the front side surface is attached to a monitor for mounting the monitor to a steel surface, the steel surface including a steel gauge of at least 1 millimeter.

Example 11 includes the adjustable magnetic mount of example 1, wherein the high friction material is selected based on a coefficient of friction, the coefficient of friction to reduce sliding of the adjustable magnetic mount along a mounting surface.

Example 12 includes the adjustable magnetic mount of example 11, wherein the coefficient of friction is selected based on at least one of a topography or a temperature of the mounting surface.

Example 13 includes an adjustable magnetic mount comprising a first section, the first section mountable on a mounting surface, the first section including at least one magnet positioned on a first region of the first section, and a high friction material surrounding the at least one magnet, the high friction material positioned at an offset from the at least one magnet to adjust a weight capacity of the adjustable magnetic mount.

Example 14 includes the adjustable magnetic mount of example 13, wherein the offset of the high friction material from the at least one magnet is (1) reduced to increase the weight capacity or (2) increased to decrease the weight capacity.

Example 15 includes the adjustable magnetic mount of example 13, wherein the high friction material is a silicone pad positioned circumferentially with respect to the at least one magnet.

Example 16 includes the adjustable magnetic mount of example 13, wherein the high friction material is positioned on either side of the at least one magnet.

Example 17 includes the adjustable magnetic mount of example 13, further including a second section, the second section including a surface for positioning an item, the item having a maximum weight of example 22 includes 6 kilograms for a mounting surface with a thickness of 1 millimeter to 3 millimeters.

Example 18 includes an adjustable magnetic mount comprising means for attaching the adjustable magnetic mount to a mounting surface, and means for regulating a friction of the adjustable magnetic mount relative to the mounting surface, wherein the means for regulating the friction is positioned at an offset from the means for attaching.

Example 19 includes the adjustable magnetic mount of example 18, wherein the means for regulating the friction is positioned circumferentially relative to the means for attaching.

Example 20 includes the adjustable magnetic mount of example 18, wherein the means for regulating the friction is modified to adjust a coefficient of friction based on material properties of the mounting surface.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An adjustable magnetic mount comprising:
a first region, the first region positioned between a first recess and a second recess, the first region including a first magnet;
a second region, the second region positioned between the second recess and a third recess, the second region including a second magnet;
a third magnet positioned below the second recess, the third magnet positioned between the first magnet and the second magnet; and
a high friction material surrounding at least one of the first, second, or third magnet.

2. The adjustable magnetic mount of claim 1, wherein the high friction material is a silicone pad positioned at an offset from the first, second, or third magnet.

3. The adjustable magnetic mount of claim 1, wherein a position of the high friction material is adjusted based on a weight capacity of the adjustable magnetic mount.

4. The adjustable magnetic mount of claim 3, wherein an offset of the high friction material from the first, second, or third magnet is (1) increased to reduce the weight capacity or (2) decreased to increase the weight capacity.

5. The adjustable magnetic mount of claim 1, further including a fourth magnet and a fifth magnet, the fourth magnet and the fifth magnet positioned on a third region and a fourth region, respectively.

6. The adjustable magnetic mount of claim 5, further including a sixth magnet positioned between the fourth magnet and the fifth magnet, the sixth magnet positioned below the third magnet.

7. The adjustable magnetic mount of claim 6, wherein at least the first, second, third, fourth, fifth, or sixth magnet is removed to accommodate a mounting surface with a steel thickness of more than 2 millimeters.

8. The adjustable magnetic mount of claim 6, wherein, when the first, second, third, fourth, fifth, and sixth magnets are positioned on a back side surface of the adjustable magnetic mount, the adjustable magnetic mount has a weight capacity of at least 8 kilograms.

9. The adjustable magnetic mount of claim 1, further including a Video Electronics Standards Association (VESA) mount slot on a front side surface, the front side surface opposite the first, second, or third magnet.

10. The adjustable magnetic mount of claim 9, wherein the VESA mount on the front side surface is attached to a monitor for mounting the monitor to a steel surface, the steel surface including a steel gauge of at least 1 millimeter.

11. The adjustable magnetic mount of claim 1, wherein the high friction material is selected based on a coefficient of friction, the coefficient of friction to reduce sliding of the adjustable magnetic mount along a mounting surface.

12. The adjustable magnetic mount of claim 11, wherein the coefficient of friction is selected based on at least one of a topography or a temperature of the mounting surface.

13. An adjustable magnetic mount comprising:
a first section, the first section mountable on a mounting surface, the first section including:
at least one magnet positioned on a first region of the first section; and
a high friction material surrounding the at least one magnet, the high friction material positioned at an offset from the at least one magnet to adjust a weight capacity of the adjustable magnetic mount.

14. The adjustable magnetic mount of claim 13, wherein the offset of the high friction material from the at least one magnet is (1) reduced to increase the weight capacity or (2) increased to decrease the weight capacity.

15. The adjustable magnetic mount of claim 13, wherein the high friction material is a silicone pad positioned circumferentially with respect to the at least one magnet.

16. The adjustable magnetic mount of claim 13, wherein the high friction material is positioned on either side of the at least one magnet.

17. The adjustable magnetic mount of claim 13, further including a second section, the second section including a surface for positioning an item, the item having a maximum weight of 22.6 kilograms for a mounting surface with a thickness of 1 millimeter to 3 millimeters.

18. An adjustable magnetic mount comprising:
means for attaching the adjustable magnetic mount to a mounting surface; and
means for regulating a friction of the adjustable magnetic mount relative to the mounting surface, wherein the means for regulating the friction is positioned at an offset from the means for attaching.

19. The adjustable magnetic mount of claim 18, wherein the means for regulating the friction is positioned circumferentially relative to the means for attaching.

20. The adjustable magnetic mount of claim 18, wherein the means for regulating the friction is modified to adjust a coefficient of friction based on material properties of the mounting surface.
